(19) United States
(12) Patent Application Publication
(10) Pub. No.: US 2021/0141554 A1
(43) Pub. Date: May 13, 2021

(54) MEMORY SYSTEM

(71) Applicant: SK hynix Inc., Gyeonggi-do (KR)

(72) Inventors: Duck Hoi KOO, Gyeonggi-do (KR); Soong Sun SHIN, Gyeonggi-do (KR)

(21) Appl. No.: 16/985,750

(22) Filed: Aug. 5, 2020

(30) Foreign Application Priority Data
Nov. 11, 2019 (KR) 10-2019-0143319

(51) Int. Cl. G06F 3/06; G06F 12/0868

(52) U.S. Cl. CPC G06F 3/0644; G06F 3/0679; G06F 3/0658; G06F 2212/1021; G06F 3/0604; G06F 12/0868; G06F 3/0659

(57) ABSTRACT

A memory system includes a plurality of nonvolatile memory apparatuses; and a controller including cache areas respectively corresponding to the plurality of nonvolatile memory apparatuses, each of the cache areas storing cache data of a corresponding nonvolatile memory apparatus, wherein the controller adjusts a size of at least one of the cache areas based on read queue depths of command queues respectively corresponding to the plurality of nonvolatile memory apparatuses.

### CROSS-REFERENCE TO RELATED APPLICATION

The present application claims priority under 35 U.S.C. § 119(a) to Korean application number 10-2019-0143319, filed on Nov. 11, 2019, in the Korean Intellectual Property Office, which is incorporated herein by reference in its entirety.

### BACKGROUND

### 1. Technical Field

Various embodiments generally relate to a memory system, and more particularly, to a memory system including a nonvolatile memory apparatus.

### 2. Related Art

A memory system may be configured to store data provided from a host device in response to a write request of the host device. Furthermore, the memory system may be configured to provide the host device with the stored data in response to a read request of the host device. The host device is an electronic device capable of processing data and examples thereof include a computer, a digital camera, a cellular phone and the like. The memory system may be embedded in the host device to operate, or may be a separate component that is electrically connected to the host device to operate.

### SUMMARY

A memory system with improved read performance is described herein.

In an embodiment, a memory system may include: a plurality of nonvolatile memory apparatuses; and a controller including cache areas respectively corresponding to the plurality of nonvolatile memory apparatuses, each of the cache areas storing cache data of a corresponding nonvolatile memory apparatus, wherein the controller adjusts a size of at least one of the cache areas based on read queue depths of command queues respectively corresponding to the plurality of nonvolatile memory apparatuses.

In an embodiment, a memory system may include: a plurality of nonvolatile memory apparatuses; and a controller including cache areas respectively corresponding to the plurality of nonvolatile memory apparatuses, wherein the controller adjusts a size of at least one of the cache areas based on a number of read commands on standby for each of the plurality of nonvolatile memory apparatuses.

In an embodiment, a memory system may include: plural memory devices; plural queues suitable for queueing read commands to be provided to the memory devices, respectively; plural caches suitable for caching data read from the memory devices, respectively; and a controller suitable for dynamically resizing at least one of the plural caches based on numbers of the read commands currently queued in the respective queues.

In accordance with the embodiments, the memory system can provide improved read performance.

### BRIEF DESCRIPTION OF THE DRAWINGS

FIG. 1 is a block diagram illustrating a memory system in accordance with an embodiment.

FIG. 2 to FIG. 4 are diagrams illustrating an operation method of a cache controller, such as that of FIG. 1, in accordance with an embodiment.

FIG. 5 is a flowchart illustrating the operation method of a cache controller, such as that of FIG. 1, in accordance with an embodiment.

FIG. 6 is a diagram illustrating a data processing system including a solid state drive (SSD) in accordance with an embodiment.

FIG. 7 is a diagram illustrating a data processing system including a memory system in accordance with an embodiment.

FIG. 8 is a diagram illustrating a data processing system including a memory system in accordance with an embodiment.

FIG. 9 is a diagram illustrating a network system including a memory system in accordance with an embodiment.

FIG. 10 is a block diagram illustrating a nonvolatile memory device included in a memory system in accordance with an embodiment.

### DETAILED DESCRIPTION

In the present invention, advantages, features and methods for achieving them will become more apparent after a reading of the following embodiments taken in conjunction with the drawings. The present invention may, however, be embodied in different forms and thus should not be construed as being limited to the embodiments set forth herein. Rather, these embodiments are provided to describe the present invention in detail to the extent that a person skilled in the art to which the invention pertains can easily practice the present invention. Throughout the specification, reference to “an embodiment,” “another embodiment” or the like is not necessarily to only one embodiment, and different references to any such phrase are not necessarily to the same embodiment(s).

It is to be understood herein that embodiments of the present invention are not limited to the particulars shown in the drawings and that the drawings are not necessarily to scale and in some instances proportions may have been exaggerated in order to more clearly depict certain features of the invention. While particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes ” and/or “including,” when used in this specification, specify the presence of the stated feature(s), step(s), operation(s), and/or element(s), but do not preclude the presence or addition of one or more other features, steps, operations, and/or elements thereof.

Hereinafter, embodiments are described in detail with reference to the drawings.

FIG. 1 is a block diagram illustrating a memory system 100 in accordance with an embodiment.

The memory system 100 may be configured to store data provided from an external host device in response to a write request of the host device. Furthermore, the memory system 100 may be configured to provide the host device with the stored data in response to a read request of the host device.

The memory system 100 may be configured as a Personal Computer Memory Card International Association (PCMCIA) card, a Compact Flash (CF) card, a smart media card, a memory stick, various multimedia cards (MMC, eMMC, RS-MMC, and MMC-Micro), various secure digital cards (SD, Mini-SD, and Micro-SD), a Universal Flash Storage (UFS), and/or a Solid State Drive (SSD).

The memory system 100 may include a controller 110 and nonvolatile memory apparatuses NVM1 to NVM4.

The controller 110 may control overall operation of the memory system 100. The controller 110 may control the nonvolatile memory apparatuses NVM1 to NVM4 in order to perform a foreground operation according to an instruction of the host device. The foreground operation may include an operation of writing data in the nonvolatile memory apparatuses NVM1 to NVM4 and reading the data from the nonvolatile memory apparatuses NVM1 to NVM4 according to the instruction of the host device, that is, the write request and the read request.

Furthermore, the controller 110 may control the nonvolatile memory apparatuses NVM1 to NVM4 in order to perform an internally required background operation independently of the host device. The background operation may include a wear leveling operation, a garbage collection operation, an erase operation, a read reclaim operation, and a refresh operation for the nonvolatile memory apparatuses NVM1 to NVM4. The background operation may include an operation of writing data in the nonvolatile memory apparatuses NVM1 to NVM4 and reading the data from the nonvolatile memory apparatuses NVM1 to NVM4, like the foreground operation.

The controller 110 may include a cache memory 111, a cache controller 112, and a memory controller 113.

The cache memory 111 may be used as a cache for the nonvolatile memory apparatuses NVM1 to NVM4. The cache memory 111 may operate at a faster read/write speed than the nonvolatile memory apparatuses NVM1 to NVM4.

The cache memory 111 may include a volatile memory apparatus or a nonvolatile memory apparatus. Examples of a volatile memory apparatus may include a Static Random Access Memory (SRAM), a Dynamic Random Access Memory (DRAM), and the like. The examples of the nonvolatile memory apparatus may include a flash memory, such as a NAND flash or a NOR flash, a Ferroelectrics Random Access Memory (FeRAM), a Phase-Change Random Access Memory (PCRAM), a Magnetoresistive Random Access Memory (MRAM), a Resistive Random Access Memory (ReRAM), and the like.

The cache memory 111 may include cache areas C1 to C4. The cache areas C1 to C4 may correspond to the nonvolatile memory apparatuses NVM1 to NVM4, respectively. Each of the cache areas C1 to C4 may store cache data of a corresponding nonvolatile memory apparatus.

Furthermore, the cache areas C1 to C4 may correspond to command queues Q1 to Q4, respectively. As will be described below, the size of each of the cache areas C1 to C4 may be expanded or reduced by the cache controller 112 based on a read queue depth of a corresponding command queue.

The cache controller 112 may control the cache memory 111. The cache controller 112 may determine whether data requested by the host device has been stored in the cache memory 111 (i.e., whether the request is a cache hit or a cache miss). When the request is the cache hit, the cache controller 112 may control the data to be provided from the cache memory 111 to the host device, and when the request is the cache miss, the cache controller 112 may control the data to be provided from the nonvolatile memory apparatuses NVM1 to NVM4 to the host device.

Then, the cache controller 112 may adjust the sizes of the cache areas C1 to C4 based on the read queue depths of the command queues Q1 to Q4. The read queue depth of the command queue may indicate the number of read commands queued in a corresponding command queue. In accordance with an embodiment, the read queue depth of the command queue may indicate the number of random read commands queued in a corresponding command queue.

Specifically, the cache controller 112 may monitor the read queue depths of the command queues Q1 to Q4 and determine whether at least one read queue depth exceeds a threshold value. For example, the threshold value may be the number of read commands that can be queued in all the command queues Q1 to Q4 (i.e., total command queue capacity) divided by the number of nonvolatile memory apparatuses NVM1 to NVM4 (that is, 4 in the example of FIG. 1). However, in accordance with another embodiment, the threshold value may be a predetermined constant value.

The cache controller 112 may expand the size of a cache area corresponding to a particular command queue having a read queue depth determined to exceed the threshold value. Specifically, the cache controller 112 may expand the size of the target cache area by increasing a ratio of the target cache area in the cache memory 111. In such a case, the cache controller 112 may reduce the size of at least one other cache area, i.e., a cache area other than the target cache area.

In accordance with an embodiment, the cache controller 112 may expand the size of the target cache area by including a memory (not illustrated in FIG. 1) in the memory system 100 as part of the target cache area.

In accordance with an embodiment, the degree of expansion (that is, an expansion amount) of the size of the target cache area and the degree of reduction (that is, a reduction amount) of the size of another cache area may be predetermined as any suitable constant value.

In accordance with an embodiment, the expansion amount of the target cache area may be a variable value depending on a read queue depth of a corresponding command queue. For example, the greater the difference by which the read queue depth exceeds the threshold value, the greater the expansion amount of the target cache area may be.

In accordance with an embodiment, the cache controller 112 may continuously monitor the read queue depths of the command queues Q1 to Q4 even after adjusting the size of at least one of the cache areas C1 to C4 and readjust the sizes of the cache areas C1 to C4 according to the monitoring result. Specifically, when a read queue depth of a command queue corresponding to the target cache area is kept lower than the threshold value for a set time after the size of the target cache area has been expanded, the cache controller 112 may restore the size of the expanded target cache area to its initial size. When the read queue depth of the command queue corresponding to the target cache area continues to be higher than the threshold value for a set time even after a size of the target cache area is expanded, the cache controller 112 may further expand the size of the target cache area.

In accordance with an embodiment, the cache controller 112 may gradually expand the size of a corresponding cache area by comparing the read queue depths of the command queues Q1 to Q4 with two or more threshold values.

The memory controller 113 may control the read operations of the nonvolatile memory apparatuses NVM1 to NVM4 based on the command queues Q1 to Q4, respectively. The command queues Q1 to Q4 may correspond to the nonvolatile memory apparatuses NVM1 to NVM4, respectively. Each of the command queues Q1 to Q4 may include one or more read commands to be transmitted to a corresponding nonvolatile memory apparatus. The command queues Q1 to Q4 may be disposed in a memory (not illustrated) included in the memory controller 113.

The nonvolatile memory apparatuses NVM1 to NVM4 may store data transmitted from the controller 110, read the stored data, and transmit the read data to the controller 110 under the control of the controller 110.

The nonvolatile memory apparatuses NVM1 to NVM4 may be connected to the controller 110 through respective input/output lines. Alternatively, the nonvolatile memory apparatuses NVM1 to NVM4 may share the same input/output line and be connected together to the controller 110 through the shared input/output line. The nonvolatile memory apparatuses NVM1 to NVM4 may operate in parallel in an interleaving manner under the control of the controller 110.

Examples of a nonvolatile memory apparatus used in the arrangement of FIG. 1 include a flash memory, such as a NAND flash or a NOR flash, a Ferroelectrics Random Access Memory (FeRAM), a Phase-Change Random Access Memory (PCRAM), a Magnetoresistive Random Access Memory (MRAM), a Resistive Random Access Memory (ReRAM), and the like.

Each nonvolatile memory apparatus may include one or more planes, one or more memory chips, one or more memory dies, or one or more memory packages.

Although FIG. 1 illustrates that the memory system 100 includes four nonvolatile memory apparatuses NVM1 to NVM4, the present invention is not limited to any particular number of nonvolatile memory apparatuses. Any suitable number of nonvolatile memory devices may be included in the memory system 100.

In response to a read request of the host device for data stored in a certain nonvolatile memory apparatus of the nonvolatile memory apparatuses NVM1 to NVM4, the controller 110 may queue a read command in the command queue of that nonvolatile memory apparatus, when the requested data is not found in the cache area of that nonvolatile memory apparatus, i.e., a cache miss occurs in attempting to retrieve the data from the corresponding cache area. Accordingly, when the cache miss rate of a particular cache area is high, the read queue depth of the corresponding command queue may be high, and when the cache hit rate of a particular cache area is high, the read queue depth of the corresponding command queue may be low.

When the host device continuously transmits random read requests to a specific nonvolatile memory apparatus, a cache miss may continuously occur for the random read requests and thus the read queue depth of the corresponding command queue may increase. This may lead to an increase in read latency for the host device.

FIG. 2 to FIG. 4 are diagrams illustrating an operation method of the cache controller 112 of FIG. 1 in accordance with an embodiment.

Referring to FIG. 2, the cache controller 112 may monitor the read queue depths of the command queues Q1 to Q4. At a certain point, the cache controller 112 may determine that the read queue depth of the command queue Q1 is “6”, the read queue depths of the command queues Q2 and Q3 is each “0”, and the read queue depth of the command queue Q4 is “1”.

The cache controller 112 may compare the read queue depth of each of the command queues Q1 to Q4 with the threshold value. The cache controller 112 may determine that the read queue depth of the command queue Q1 exceeds the threshold value and the read queue depths of the command queues Q2 to Q4 do not exceed the threshold value.

Such a situation may occur when random read requests of the host device are concentrated on the nonvolatile memory apparatus NVM1 as described above. This may lead to an increase in the read latency for the host device. Furthermore, the nonvolatile memory apparatuses NVM2 to NVM4 do not operate by actively utilizing an interleaving scheme because there is only one read command in the command queues Q2 to Q4, so the operation efficiency of the nonvolatile memory apparatuses NVM1 to NVM4 is low.

Referring to FIG. 3, the cache controller 112 may adjust the ratios of the cache areas C1 to C4 in the cache memory 111 according to the result of monitoring the command queues Q1 to Q4 in the situation of FIG. 2. Specifically, since the read queue depth of the command queue Q1 exceeds the threshold value, the cache controller 112 may determine the cache area C1 as the target cache area. Accordingly, the cache controller 112 may expand the size of the target cache area C1 by increasing the ratio of the target cache area C1 to the total cache area in the cache memory 111, which remains the same. This may be done by increasing the size of C1 and decreasing the size of one or more of the other cache areas (C2, C3 and/or C4).

In the illustrated embodiment, the size of each of the cache areas is adjusted. As a result of this operation, the read queue depths of the command queues Q1 to Q4 may be changed as illustrated in FIG. 3. First, by expanding the size of the target cache area C1, the cache hit rate of the target cache area C1 may be increased and thus the read queue depth of the command queue Q1 may be lowered. Accordingly, the read latency for the host device can be improved.

When the size of each of the cache areas C2 to C4 is reduced, the cache miss rates of the cache areas C2 to C4 may be increased and as a consequence, the read queue depths of the command queues Q2 to Q4 may be increased. As can be seen, some of the load concentrated on the nonvolatile memory apparatus NVM1 is distributed to the nonvolatile memory apparatuses NVM2 to NVM4. Therefore, the nonvolatile memory apparatuses NVM1 to NVM4 may perform read operations 31 in parallel by actively utilizing the interleaving scheme to attain maximum operation efficiency.

Although FIG. 3 illustrates a case the size of each of the cache areas C2 to C4is uniformly reduced in the cache memory 111, the cache controller 112 may reduce the size of only one or two of the cache areas C2 to C4 in accordance with an embodiment.

Referring to FIG. 4, the cache controller 112 may expand the size of the target cache area C1 up to an area C11 by using a separate memory 114 included in the memory system 100, instead of adjusting the ratio of the area of C1 to the total cache area, which remains the same. That is, unlike the method in which the size of the target cache area C1 is expanded while the area of at least one of the other cache areas C2 to C4 is reduced, the size of the target cache area C1 may be expanded using the separate memory 114 in FIG. 4. In FIG. 4, the sizes of the remaining cache areas C2 to C4 may be substantially maintained.

The effect of expanding the size of the target cache area C1 using a separate memory may be similar to that described in FIG. 3 in which relative proportions of the cache areas are adjusted. By expanding the size of the target cache area C1, the read queue depth of the command queue Q1 may be lowered. Accordingly, the read latency for the host device can be improved. By substantially maintaining the sizes of the cache areas C2 to C4, the existing cache performance can be substantially maintained.

In accordance with an embodiment, the controller 110 mixes the methods illustrated in FIG. 3 and FIG. 4, that is, uses the separate memory 114 to expand the target cache area, while adjusting the ratio of the target cache area to the total cache area in the cache memory 111, such that the size of one or more of the cache areas C2 to C4 are reduced.

FIG. 2 to FIG. 4 illustrate a case where the size of one target cache area C1 is expanded when the read queue depth of one command queue Q1 exceeds the threshold value. When each of the read queue depths of two or more command queues exceeds the threshold value, sizes of the two or more corresponding target cache areas may be expanded according to the aforementioned method.

FIG. 5 is a flowchart illustrating the operation method of the cache controller 112 of FIG. 1 in accordance with an embodiment.

Referring to FIG. 5, in step S101, the cache controller 112 may monitor the read queue depths of each of the command queues Q1 to Q4.

In step S102, the cache controller 112 may determine whether at least one read queue depth exceeds the threshold value. When it is determined that no read queue depth exceeds the threshold value, the procedure may return to step S101. That is, the cache controller 112 may continuously monitor the read queue depths of the command queues Q1 to Q4. On the other hand, when it is determined that at least one read queue depth exceeds the threshold value, the procedure may proceed to step S103.

In step S103, the cache controller 112 may expand the size of a target cache area corresponding to a command queue having a read queue depth determined to exceed the threshold value.

FIG. 6 is a diagram illustrating a data processing system 1000 including a solid state drive (SSD) 1200 in accordance with an embodiment. Referring to FIG. 6, the data processing system 1000 may include a host device 1100 and the SSD 1200.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operation of the SSD 1200. The controller 1210 may include a host interface 1211, a control component 1212, a memory 1213, an error correction code (ECC) component 1214, and a memory interface 1215.

The host interface 1211 may exchange a signal SGL with the host device 1100 through the signal connector 1250. The signal SGL may include a command, an address, data, and so forth. The host interface 1211 may interface the host device 1100 and the SSD 1200 according to the protocol of the host device 1100. For example, the host interface 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-E) and/or universal flash storage (UFS).

The control component 1212 may analyze and process the signal SGL received from the host device 1100. The control component 1212 may control operations of internal function blocks according to firmware or software for driving the SSD 1200. The memory 1213 may be used as a working memory for driving such firmware or software. The memory 1213 may include the cache controller 112 and cache memory 111 shown in FIG. 1.

The ECC component 1214 may generate the parity data of data to be transmitted to at least one of the nonvolatile memory devices 1231 to 123n. The generated parity data may be stored together with the data in the nonvolatile memory devices 1231 to 123n. The ECC component 1214 may detect an error of the data read from at least one of the nonvolatile memory devices 1231 to 123n, based on the parity data. If a detected error is within a correctable range, the ECC component 1214 may correct the detected error.

The memory interface 1215 may provide control signals such as commands and addresses to at least one of the nonvolatile memory devices 1231 to 123n, according to control of the control component 1212. Moreover, the memory interface 1215 may exchange data with at least one of the nonvolatile memory devices 1231 to 123n, according to control of the control component 1212. For example, the memory interface 1215 may provide the data stored in the buffer memory device 1220 to at least one of the nonvolatile memory devices 1231 to 123n, or provide the data read from at least one of the nonvolatile memory devices 1231 to 123n to the buffer memory device 1220.

The memory interface 1215 may include memory controller 113 shown in the 113.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be properly terminated when a sudden power-off occurs. The auxiliary power supply 1241 may include large capacity capacitors.

The signal connector 1250 may be configured by any of various types of connectors depending on an interface scheme between the host device 1100 and the SSD 1200.

The power connector 1260 may be configured by any of various types of connectors depending on a power supply scheme of the host device 1100.

FIG. 7 is a diagram illustrating a data processing system 2000 including a memory system 2200 in accordance with an embodiment. Referring to FIG. 7, the data processing system 2000 may include a host device 2100 and the memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operation of the memory system 2200. The controller 2210 may be configured in the same manner as the controller 110 shown in FIG. 1 or the controller 1210 shown in FIG. 6.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data is temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250, to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the memory system 2200. The connection terminal 2250 may be configured into various types depending on an interface scheme between the host device 2100 and the memory system 2200. The connection terminal 2250 may be disposed on any one side of the memory system 2200.

FIG. 8 is a diagram illustrating a data processing system 3000 including a memory system 3200 in accordance with an embodiment. Referring to FIG. 8, the data processing system 3000 may include a host device 3100 and the memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operation of the memory system 3200. The controller 3210 may be configured in the same manner as the controller 110 shown in FIG. 1 or the controller 1210 shown in FIG. 6.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

FIG. 9 is a diagram illustrating a network system 4000 including a memory system 4200 in accordance with an embodiment. Referring to FIG. 9, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 100 shown in FIG. 1, the memory system 1200 shown in FIG. 6, the memory system 2200 shown in FIG. 7 or the memory system 3200 shown in FIG. 8.

FIG. 10 is a block diagram illustrating a nonvolatile memory device 300 included in a memory system in accordance with an embodiment. Referring to FIG. 10, the nonvolatile memory device 300 may include a memory cell array 310, a row decoder 320, a data read/write block 330, a column decoder 340, a voltage generator 350, and control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operation of the nonvolatile memory device 300, based on control signals provided from the external device. For example, the control logic 360 may control operations of the nonvolatile memory device 300 such as read, write and erase operations of the nonvolatile memory device 300.

While various embodiments have been illustrated and described, it will be understood to those skilled in the art that the embodiments described are examples only. Accordingly, the present invention is not limited by or to any of the described embodiments. Rather, the present invention encompasses all modifications and variations of any of the disclosed embodiments that fall within the scope of the claims.

What is claimed is:

1. A memory system comprising:
a plurality of nonvolatile memory apparatuses; and
a controller including cache areas respectively corresponding to the plurality of nonvolatile memory apparatuses, each of the cache areas storing cache data of a corresponding nonvolatile memory apparatus,
wherein the controller adjusts a size of at least one of the cache areas based on read queue depths of command queues respectively corresponding to the plurality of nonvolatile memory apparatuses.

2. The memory system according to claim 1, wherein, when it is determined that a read queue depth of at least one of the command queues exceeds a threshold value, the controller expands a size of a cache area corresponding to a nonvolatile memory apparatus of the command queue exceeding the threshold value.

3. The memory system according to claim 2, wherein the controller expands the size of the corresponding cache area by reducing a size of at least one other cache area, among the cache areas.

4. The memory system according to claim 2,
wherein the controller further includes a memory, and
wherein the controller expands the size of the corresponding cache area by including the memory as part of the corresponding cache area.

5. The memory system according to claim 1, wherein the controller restores the size of the at least one cache area to its initial size based on a change in the read queue depth of a command queue corresponding to the at least one cache area after the size of the at least one cache area is adjusted.

6. The memory system according to claim 1, wherein, in response to a read request for data, which is transmitted from a host device, the controller queues a read command for reading the data in a command queue corresponding to a nonvolatile memory apparatus, in which the data has been stored, when it is determined that a cache miss is found for the data in a cache area corresponding to the nonvolatile memory apparatus.

7. The memory system according to claim 1, wherein each of the read queue depths is represented by a number of read commands queued in a corresponding command queue.

8. A memory system comprising:
a plurality of nonvolatile memory apparatuses; and
a controller including cache areas respectively corresponding to the plurality of nonvolatile memory apparatuses,
wherein the controller adjusts a size of at least one of the cache areas based on a number of read commands on standby for each of the plurality of nonvolatile memory apparatuses.

9. The memory system according to claim 8, wherein, when it is determined that a number of read commands on standby for at least one of the nonvolatile memory apparatuses exceeds a threshold value, the controller expands the size of a cache area corresponding to the at least one nonvolatile memory apparatus.

10. The memory system according to claim 9, wherein the controller expands the size of the corresponding cache area by reducing a size of at least one other cache area among the cache areas.

11. The memory system according to claim 9,
wherein the controller further includes a memory, and
wherein the controller expands the size of the corresponding cache area by including the memory as part of the corresponding cache area.

12. The memory system according to claim 8, wherein the controller restores the size of the at least one cache area to its initial size based on a change in the number of read commands waiting to be executed by a corresponding nonvolatile memory apparatus after the size of the at least one cache area is adjusted.

13. The memory system according to claim 8, wherein, in response to a read request for data, which is transmitted from a host device, the controller queues a read command for reading the data in a command queue corresponding to a nonvolatile memory apparatus, in which the data has been stored, when it is determined that a cache miss is found for the data in a cache area corresponding to the nonvolatile memory apparatus.

14. A memory system comprising:
plural memory devices;
plural queues suitable for queueing read commands to be provided to the memory devices, respectively;
plural caches suitable for caching data read from the memory devices, respectively; and
a controller suitable for dynamically resizing at least one of the plural caches based on numbers of the read commands currently queued in the respective queues.
